(19) United States
(12) Patent Application Publication
(10) Pub. No.: US 2010/0283577 A1
(43) Pub. Date: Nov. 11, 2010

(54) MONITORING APPARATUS, AND METHOD FOR DETERMINING A POWER CONSUMPTION AUTHORIZATION

(75) Inventor: MICHAEL KOCH, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Moeller Gebaudeautomation GmbH, Schrems (AT)

(21) Appl. No.: 12/774,343

(22) Filed: May 5, 2010

Related U.S. Application Data
(60) Provisional application No. 61/176,265, filed on May 7, 2009.

(30) Foreign Application Priority Data
May 7, 2009 (AT) A 699/2009

(51) Int. Cl. G06F 7/04; H02H 3/20

(52) U.S. Cl. 340/5.2; 361/90

(57) ABSTRACT

A monitoring apparatus for determining an authorization to consume electric power of an electric consumer connected to an electric power supply network includes a device for recording and/or receiving measurement data for recognizing a current flow in at least a part of the electric power supply network. A communications unit queries and receives an identifier of the electric consumer, and a comparison unit compares a received identifier with at least one stored reference identifier.

### CROSS-REFERENCES TO RELATED APPLICATIONS

This application claims the benefit of prior filed U.S. provisional Application No. 61/176,265, filed May 7, 2009, pursuant to 35 U.S.C. 119(e).

This application also claims the priority of Austrian Patent Application, Serial No. A 699/2009, filed May 7, 2009, pursuant to 35 U.S.C. 119(a)-(d).

The contents of U.S. provisional Application No. 61/176,265 and Austrian Patent Application, Serial No. A 699/2009 are incorporated herein by reference in their entirety as if fully set forth herein.

### BACKGROUND OF THE INVENTION

The present invention relates to a monitoring apparatus for determining the authorization to consume electric power of an electric consumer connected to an electric power supply network. The present invention also relates to a method for determining a power consumption authorization.

The following discussion of related art is provided to assist the reader in understanding the advantages of the invention, and is not to be construed as an admission that this related art is prior art to this invention.

The unauthorized consumption of electric power from electric supply networks can lead to numerous problems. Often, especially old electric appliances that have a high power consumption are kept in operation at socket outlets for which the user or operator of the respective electric appliance does not pay any electricity costs. Financial damage is thus inflicted upon the operator of a building because he needs to pay for the costs for such electric power. This also causes damage to the economy in general and to the environment because the respective appliances often use many times more power than is consumed by comparatively modern appliances. Moreover, such appliances are often in operation without there being any need for this. Examples for such unauthorized consumption of power range from refrigerators and lighting fixtures in the cellars of residential buildings up to electric vehicles which are charged at freely accessible socket outlets in underground parking garages.

A further aspect of unauthorized consumption of power concerns the connection of unsafe electric appliances in electric power supply networks which supply sensitive areas with power, the failure of which needs to be prevented under all circumstances, e.g. computer server systems, air-traffic control systems, intensive care stations, etc. The connection of an unsafe electric appliance can lead to the failure of the installation, leading to costs and/or the endangerment of human lives. The connection of such appliances in other areas can also lead to the endangerment of human lives, such as the fire in the Kaprun glacier railway on 11 Nov. 2000 that was caused by a defective electric heater that was connected in an authorized manner. 155 people lost their lives in this fire.

Currently, there are no means available which allow for a simple safeguard of an electric power supply network against unauthorized power consumption or power theft which is difficult to circumvent or manipulate.

It would therefore be desirable and advantageous to provide an improved monitoring apparatus and a method for determining a power consumption authorization to obviate prior art shortcomings and to enable reliable determination or prevention of an unauthorized operation of an electric consumer in an electric power supply network.

### SUMMARY OF THE INVENTION

According to one aspect of the present invention, a monitoring apparatus for determining an authorization to consume electric power by an electric consumer connected to an electric power supply network includes a device for recording and/or receiving measurement data for recognizing a current flow in at least one part of the electric power supply network, a communications unit for querying and receiving an identifier of the electric consumer, and a comparison unit for comparing a received identifier from the communications unit with a stored reference identifier.

As a result, the unauthorized operation of an electric consumer in an electric power supply network can be determined in a secure manner. As a result, at least a part of the electric power supply network can subsequently be switched off in the case of unauthorized consumption of power, through which the consumption or theft of electric power can be prevented. In this way, hazards for humans and/or installations which are caused by such an unauthorized operation of an electric appliance can be prevented effectively.

According to another advantageous feature of the present invention, the recording and/or receiving device includes a measurement data interface for connection of a measurement unit.

According to another advantageous feature of the present invention, the communications unit may include an interface for powerline communication, e.g. a powerline interface. The communications unit may also include an interface for wireless communication, e.g. an interface for an RFID or GSM interface.

According to another advantageous feature of the present invention, the comparison unit can be configured for comparing the received identifier with a predefined list of reference identifiers.

According to another advantageous feature of the present invention, the recording and/or receiving device may include a measurement unit for recognizing the current flow in the part of the electric power supply network. The measurement unit can hereby be constructed as a current measuring device to include a Hall sensor, a summation current transformer, a Foerster probe, and/or a shunt resistor. As an alternative, the measurement unit can be constructed as an impedance measuring device.

According to another advantageous feature of the present invention, the measurement unit may include a pulse generator for generating at least one electric pulse in the one part of the electric power supply network, and a receiver for receiving a pulse response to the at least one electric pulse. The receiver may be configured as a broadband receiver.

According to another advantageous feature of the present invention, a further communications unit may be provided for transmitting a status message and/or a switching order.

According to another aspect of the present invention, an identifier module for arrangement in or on an electric consumer includes a memory for storing at least one identifier of the electric consumer, and a telecommunications unit for receiving a query of a monitoring apparatus as set forth above, and transmitting the identifier to the monitoring apparatus.

According to still another aspect of the present invention, a circuit breaker, e.g. a miniature circuit breaker or a residual-current circuit breaker, includes break contacts for a predeterminable disconnection of at least one conductor of an electric power supply network, and a monitoring apparatus as set forth above, with the monitoring apparatus being operatively connected, at least indirectly, with the break contacts for triggering an opening of the break contacts.

According to yet another aspect of the present invention, a circuit breaker, e.g. a miniature circuit breaker or a residual-current circuit breaker, includes break contacts for a predeterminable disconnection of at least one conductor of an electric power supply network, and a control interface for receiving a switching order of a monitoring apparatus so constructed as to include a communications unit for transmitting a status message and/or a switching order, with the control interface being operatively connected, at least indirectly, with the break contacts for triggering an opening of the break contacts.

According to still another aspect of the present invention, an electric indoor installation arrangement includes an electric power supply network to which an electric consumer is connected, and a monitoring apparatus as set forth above, wherein the electric consumer is configured in one of two ways, a first way in which the electric consumer includes an identifier module as set forth above, a second way in which the electric consumer is operatively connected with an identifier module as set forth above by means of circuitry.

According to still another aspect of the present invention, a method for determining the authorization to consume electric power of an electric consumer connected to an electric power supply network, includes the steps in sequence of recognizing a current flow in at least one part of the electric power supply network by a monitoring apparatus, querying an identifier of the electric consumer through telecommunication, receiving the identifier of the electric consumer through telecommunication, and comparing the received identifier of the electric consumer with a reference identifier.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a block diagram of one embodiment of an electric indoor installation arrangement in accordance with the present invention;

FIG. 2 is a block diagram of one embodiment of a monitoring apparatus in accordance with the present invention;

FIG. 3 is a block diagram of another embodiment of an electric indoor installation arrangement in accordance with the present invention;

FIG. 4 is a block diagram of another embodiment of a monitoring apparatus in accordance with the present invention;

FIG. 5 is a block diagram of yet another embodiment of an electric indoor installation arrangement in accordance with the present invention; and

FIG. 6 is a block diagram of an identity module in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIGS. 2 to 4, there are shown block diagrams of preferred embodiments of a monitoring apparatus 1 for determining the power consumption authorization of an electric consumer 3 connected to an electric power supply network 2, with the monitoring apparatus 1 having a device 22 for recording and/or receiving measurement data for recognizing the current flow in at least one part 5 of the electric power supply network 2. The monitoring apparatus 1 includes at least one communications unit 6 for querying and receiving an identifier of the electric consumer 3, and a comparison unit 7 for comparing a received identifier with at least one stored reference identifier.

The unauthorized operation of the electric consumer 3 in the electric power supply network 2 can thus be reliably detected. As a result, the at least one part 5 of the electric power supply network 2 can subsequently be switched off in the case of unauthorized consumption of power, thus preventing the consumption or theft of power. As a result, the hazards for humans and/or installations which arise by such unauthorized operation of the electric consumer 3 can be removed effectively.

The monitoring apparatus 1 can be constructed as a separate apparatus with a separate housing which is provided for attachment to a further apparatus such as consumer 3 for example, or as a module which is implemented in a further apparatus such as a switch or a control unit of an indoor automation system.

The monitoring apparatus 1 is provided for determining the power consumption authorization of the electric consumer 3 which is connected to the electric power supply network 2, with the electric power supply network 2 preferably concerning any kind of network for the distribution or provision of electric power in the form of line-bound electricity, e.g. the conventional 380/240V three-phase network which is conventionally used in domestic installations in Europe. In the following description, the term consumer 3 will be used for the sake of simplicity to designate the electric consumer 3.

The term “power consumption authorization” preferably designates an authorization for operating the consumer 3 which takes electric current from the electric power supply network 2 for its operation. In the event the consumer 3 has such a power consumption authorization, it may be operated in the respective electric power supply network 2. In the event, the consumer 3 does not have such a power consumption authorization, it is not permitted for operation in such an electric power supply network 2. Such an operation therefore represents the theft of electric power and may cause hazards to humans and installations. The present invention allows distinguishing between consumers 3 which have or do not have a power consumption authorization. Respective counter-measures can be taken in cases where a consumer 3 does not have a power consumption authorization.

The monitoring apparatus 1 is provided for the purpose to check the legality of taking electric power during the occurrence of a current flow in at least one conductor 17 of the electric power supply network 2 or the consumption of electric power. For this purpose, the monitoring apparatus 1 has a device 22 for recording and/or receiving measurement data for recognizing a current flow in the at least one part 5 of the electric power supply network 2. The recording and/or receiving device 22 has at least one measurement data interface or is constructed as such, for connection to a measurement unit 4. A measurement data interface is preferably arranged as any kind of an interface which is provided or constructed for transmitting or sending measurement data from the measurement unit 4 to the monitoring apparatus 1. Advantageously, the measurement data interface is arranged as a line-bound electric or optical interface. It may be beneficial to make the measurement unit 4 part of a circuit breaker 15 for example.

It can be provided as an alternative and/or in addition to the aforementioned arrangement of the recording and/or receiving device 22 that the recording and/or receiving device 22 includes at least one measurement unit 4 or is constructed as such a measurement unit 4, for recognizing the current flow in the at least one part 5 of the electric power supply network 2. This allows a direct detection of the consumption of electric power by the monitoring apparatus 1. The measurement unit 4 is preferably arranged as any kind of a measuring device which is suitable for detecting the consumption of electric power from an electric power supply network 2 or a current flow in a conductor 17. The measurement unit 4 can be constructed as a current measuring device which can include at least one Hall sensor, summation current transformer, Foerster probe and/or shunt resistor, through which the current flow is detected directly. It can also be provided additionally or alternatively to the above that the measurement unit 4 is constructed as an impedance measuring device. As a result, the changed line impedance as a consequence of a consumer 3 that has been put into operation can be detected. It can further be provided that the measurement unit 4 includes a pulse generator for generating at least one electric pulse at least in the part 5 of the electric power supply network 2, and a preferably broad-band receiver for receiving pulse responses to the at least one electric pulse. The transmission function of a conductor 5 together with all consumers 3 connected to the same can be determined by a pulse response. A consumer 3 connected to this conductor can thus also be detected. In addition to the simple detection of a current flow, the kind of consumer 3 can also be detected by an evaluation of the measurement data of the measurement unit 4, especially the impedance measurement and the pulse response.

The communications unit 6 of the monitoring apparatus 1 is used for querying and receiving an identifier of the electric consumer 3. It is provided for this purpose that the consumer 3 has an identifier module 11 which will be described furtherbelow. The communications unit 6 can be constructed for line-bound data transmission or wireless communication, which have different advantages and disadvantages each depending on the operational environment. Advantageously, the communications unit 6 has an interface for power network communication which can be configured as a powerline interface. Further wiring within an electric indoor installation arrangement 19 is thus no longer necessary. When designing the communications unit 6 for wireless communication, the communications unit 6 has an interface for wireless communication, which can be constructed as an RFID or GSM interface.

The monitoring apparatus 1 can include an additional communications unit 10 for transmitting a status message, e.g. to a controller of an indoor automation system or a user terminal device such as a PDA, and/or a switching order, e.g. to a controller 15 or a disconnector switch. As a result, the monitoring apparatus 1 can switch off at least a part 5 of the electric power supply network 2 upon detecting an unauthorized consumption of electric power and/or can send a warning message, e.g. to a service technician.

The comparison unit 7 of the monitoring apparatus 1 is provided for comparing a received identifier with at least one stored reference identifier, through which a consumer 3 can be recognized as a consumer 3 authorized for consuming electric power. It can be provided in this case that all consumers 3 have the same identifier. It is preferred however to assign one identifier individually to a consumer 3, and to construct the comparison unit 7 for comparing the received identifier with a predefined list of reference identifiers. It is provided for this purpose that the monitoring apparatus 1 has at least one electronic memory for storing the at least one reference identifier.

In addition to the afore-mentioned modules, the monitoring apparatus 1 can include further modules such as a power supply unit or a user interface.

FIGS. 2 and 4 show two preferred embodiments of monitoring apparatuses 1 in accordance with the invention in the form of simplified block diagrams, with the connections between the individual blocks being used for illustrating an operative circuit connection between the two blocks.

FIG. 2 shows a first preferred embodiment of a monitoring apparatus 1 in accordance with the invention which comprises a device 22 for recording and/or for receiving measurement data. The recording and/or receiving device 22 is constructed as a measurement unit 4 or is constructed arranged as such, and is connected by means of a circuitry with a control unit 20. The comparison unit 7 is connected to the control unit 20 which is preferably arranged to comprise a microcontroller, a microprocessor, an FPGA, a PDA or the like, and further to the communications unit 6 which is constructed as an interface for powerline communication. The monitoring apparatus 1 according to FIG. 2 further includes an additional communications unit 10 which is also triggered by the control unit 20.

FIG. 4 shows a simple second preferred embodiment of a monitoring apparatus 1 in accordance with the invention which comprises a device 22 for recording and/or receiving measurement data. The recording and/or receiving device 22 is constructed as a measurement data interface and connected by means of a circuitry with a comparison unit 7, which on its part is connected by means of circuitry with a communications unit 6 constructed as an interface for wireless data transmission. The communications unit 6 preferably includes all modules which are required for sending a query and receiving an identifier of a consumer 3.

It is provided in accordance with the invention that the consumers 3 which have an authorization to consume electric power have the capability to transmit a respective identifier to the monitoring apparatus 1. An identifier module 11 is therefore provided according to a further refinement of the invention for arrangement in or on an electric consumer 3. Identifier modules 11 have a memory 12 for storing at least one identifier of the electric consumer 3 and a telecommunications unit 13 which is arranged for receiving a query from the monitoring apparatus 1 and for transmitting the identifier to the monitoring apparatus 1. The telecommunications unit 13 is therefore arranged in a respective opposite way to the communications unit 6 of the monitoring apparatus 1.

FIG. 6 shows a preferred embodiment of an identifier module 11 with the aforementioned modules as a block diagram. The memory 12 is connected by means of circuitry with the telecommunications unit 13.

It can be provided that an identifier module 11 is arranged directly in or on a consumer 3. Advantageously, the identifier module 11 is arranged within the consumer 3 in a manner protected against manipulation. The identifier module 11 can be constructed as a plug-in module and includes an input plug for connection with an electric power supply network 2 and an output plug for connection with the consumer 3. Such a plug-in module can be arranged in the manner of an intermediate plug which is connected to a socket outlet of the electric power supply network 2 and which has a socket outlet itself to which the consumer 3 is connected. Identifier modules 11 which are arranged in this way have the advantage that an authorized user is granted the possibility of essentially free operation of a consumer 3 in the area of the electric power supply network 2.

As described above, it can be provided that upon recognizing unauthorized consumption of electric power by a consumer the respective part 5 of the electric power supply network 2 is switched off. For this purpose, a circuit breaker 15, preferably a miniature circuit breaker and/or a residual-current circuit breaker, is provided and includes break contacts 16 or switching contacts for the purpose of predeterminable disconnecting at least one conductor 17 of the electric power supply network 2. The circuit breaker 15 includes the monitoring apparatus 1 which is operatively connected at least indirectly with the break contacts 16 for triggering an opening process of the break contacts 16 in a predeterminable way. The monitoring apparatus 1 may be operatively connected either mechanically or electrically with a trigger of the circuit breaker 15.

It can be provided alternatively to the arrangement of the aforementioned combination of circuit breaker 15 and monitoring apparatus 1 that the circuit breaker 15 includes a control interface 18 for receiving a switching order of the monitoring apparatus 1. The control interface 18 is operatively connected at least indirectly with the break contacts 16 for releasing an opening process of the break contacts 16 in a predeterminable manner. The control interface 18 can be arranged as a mechanical or electric interface which can act upon a trigger of the circuit breaker 15. Many circuit breakers 15 already have such interfaces which are provided especially for coupling several circuit breakers 15.

The present invention further relates to an electric indoor installation arrangement 19, comprising an electric power supply network 2, to which at least one electric consumer 3 is connected, with the electric indoor installation arrangement 19 having a monitoring apparatus 1 in accordance with the invention, and the electric consumer 3 includes an identifier module 11 or is operatively connected by means of circuitry with an identifier module 11.

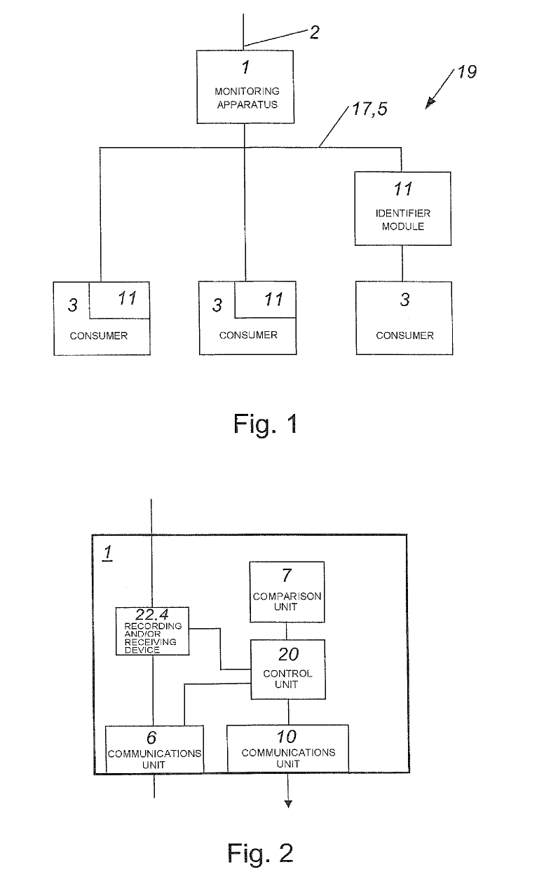

FIGS. 1, 3 and 5 show exemplary preferred embodiments of such electric indoor installations 19.

An electric indoor installation arrangement 19 according to FIG. 1 includes a monitoring apparatus 1, through which a conductor 17 of the electric power supply network 2 is guided. The monitoring apparatus 1 is preferably arranged according to FIG. 2. Three consumers 3 are connected after the monitoring apparatus 1, with two of the consumers 3 having an integrated identifier module 11 and an identifier module 11 arranged as a plug-in module being arranged between the consumer 3 and the monitoring apparatus 1. The communication between the identifier modules 11 and the monitoring apparatus 1 occurs by means of powerline.

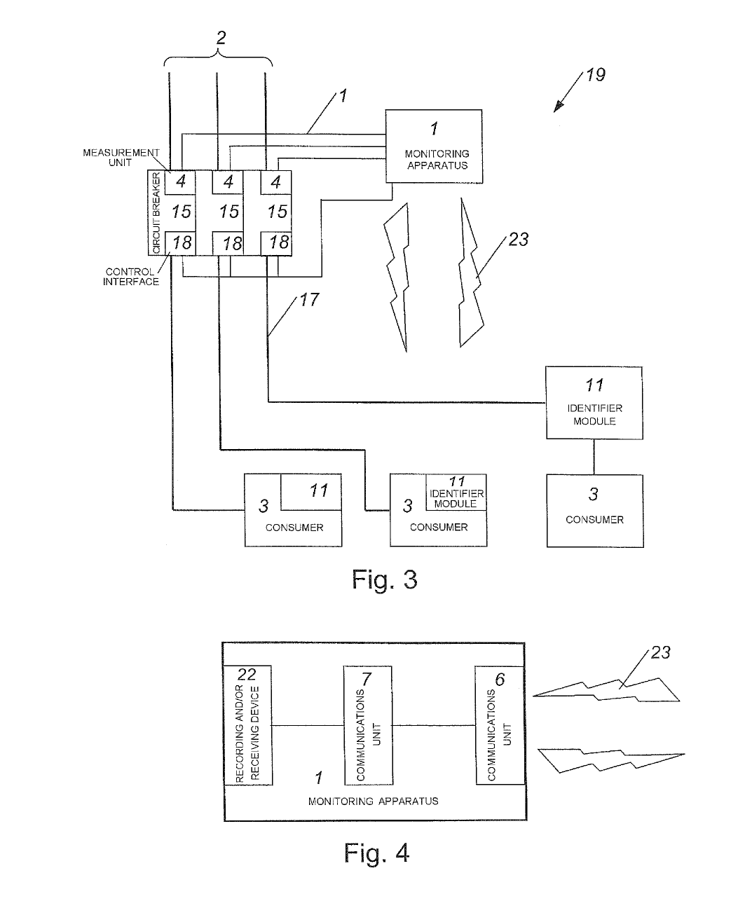

FIG. 3 shows an electric indoor installation arrangement 19 which includes three circuit breakers 15 in accordance with the invention. Each circuit breaker 15 has a measurement unit 4 connected with the monitoring apparatus 1 by means of circuitry. The circuit breakers 15 are further each connected with the monitoring apparatus 1 by means of their control interface 18 and can be triggered by the monitoring apparatus 1 when a non-authorized consumer 3, i.e. a consumer 3 without an identifier module 11, is connected to the electric power supply network. The querying of the identifiers occurs by means of wireless data transmission, as is indicated by the arrows 23.

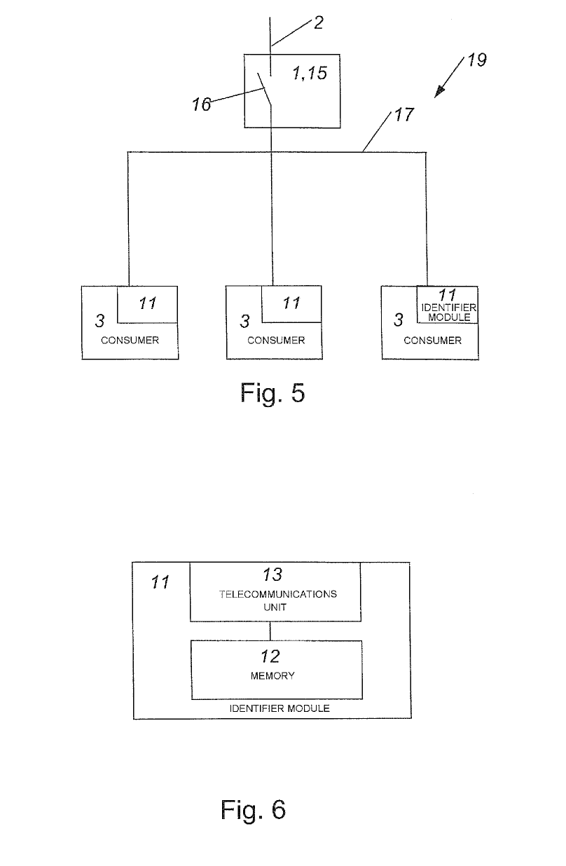

In an electric indoor installation arrangement 19 according to FIG. 5, a monitoring apparatus 1 is provided which is implemented together with the measurement unit 4 (not shown) in a circuit breaker 15, with the communication with the identifier modules 11 occurring by means of powerline.

In a method for determining an authorization for consuming electric power of an electric consumer 3 which is connected to an electric power supply network 2, a current flow is recognized in at least one part 5 of the electric power supply network 2 by a monitoring apparatus 1, identifications of electric consumers 3 are queried subsequently by means of telecommunications, identifications of electric consumers 3 are received subsequently by means of telecommunications, and a received identifier of a electric consumer 3 is compared subsequently with at least one reference identifier.

The unauthorized operation of an electric consumer 3 in an electric power supply network 2 can thus be determined in a secure manner. As a result, at least a part of the electric power supply network 2 can subsequently be switched off in the case of unauthorized consumption of power, through which the consumption or theft of electric power can be prevented. In this way, hazards for humans and/or installations which are caused by such an unauthorized operation of an electric appliance can be prevented effectively.

In a further refinement of the invention, it is provided that when the identifier of the electric consumer 3 corresponds with the at least one reference identifier, the consumption of electric power by the electric consumer 3 is recognized as an authorized consumption of electric power. It can be provided that this is indicated or output. When a consumer 3 is recognized as not being authorized to consume electric power, it can be provided in a further development of the invention that this is indicated or output, and especially the respective circuit is shut off to which the unauthorized consumer 3 is connected.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A monitoring apparatus for determining an authorization to consume electric power by an electric consumer connected to an electric power supply network, said monitoring apparatus comprising:
a device for recording and/or receiving measurement data for recognizing a current flow in at least one part of the electric power supply network;
a communications unit for querying and receiving an identifier of the electric consumer; and
a comparison unit for comparing a received identifier from the communications unit with a stored reference identifier.

2. The monitoring apparatus of claim 1, wherein the recording and/or receiving device includes a measurement data interface for connection of a measurement unit.

3. The monitoring apparatus of claim 1, wherein the communications unit includes an interface for powerline communication.

4. The monitoring apparatus of claim 1, wherein the communications unit includes an interface for a powerline interface.

5. The monitoring apparatus of claim 1, wherein the communications unit includes an interface for wireless communication.

6. The monitoring apparatus of claim 1, wherein the communications unit includes an interface for an RFID or GSM interface.

7. The monitoring apparatus of claim 1, wherein the comparison unit is configured for comparing the received identifier with a predefined list of reference identifiers.

8. The monitoring apparatus of claim 1, wherein the recording and/or receiving device includes a measurement unit for recognizing the current flow in the part of the electric power supply network.

9. The monitoring apparatus of claim 8, wherein the measurement unit is constructed as a current measuring device which includes at least one member selected from the group consisting of a Hall sensor, a summation current transformer, a Foerster probe, and a shunt resistor.

10. The monitoring apparatus of claim 8, wherein the measurement unit is constructed as an impedance measuring device.

11. The monitoring apparatus of claim 8, wherein the measurement unit comprises a pulse generator for generating at least one electric pulse in the one part of the electric power supply network, and a receiver for receiving a pulse response to the at least one electric pulse.

12. The monitoring apparatus of claim 11, wherein the receiver is a broadband receiver.

13. The monitoring apparatus of claim 1, further comprising a further communications unit for transmitting a status message and/or a switching order.

14. An identifier module for arrangement in or on an electric consumer, comprising:
a memory for storing at least one identifier of the electric consumer; and
a telecommunications unit for receiving a query of a monitoring apparatus as set forth in claim 1, and transmitting the identifier to the monitoring apparatus.

15. The identifier module of claim 14, constructed as a plug-in module which includes an input plug for connection with an electric power supply network, and an output plug for connection with the electric consumer.

16. A circuit breaker, comprising:
break contacts for a predeterminable disconnection of at least one conductor of an electric power supply network; and
a monitoring apparatus as set forth in claim 1, said monitoring apparatus being operatively connected, at least indirectly, with the break contacts for triggering an opening of the break contacts.

17. The circuit breaker of claim 16, constructed as a miniature circuit breaker or a residual-current circuit breaker.

18. A circuit breaker, comprising:
break contacts for a predeterminable disconnection of at least one conductor of an electric power supply network; and
a control interface for receiving a switching order of a monitoring apparatus as set forth in claim 13, said control interface being operatively connected, at least indirectly, with the break contacts for triggering an opening of the break contacts.

19. The circuit breaker of claim 18, constructed as a miniature circuit breaker or a residual-current circuit breaker.

20. An electric indoor installation arrangement, comprising:
an electric power supply network to which an electric consumer is connected; and
a monitoring apparatus as set forth in claim 1,
wherein the electric consumer is configured in one of two ways, a first way in which said electric consumer includes an identifier module adapted for arrangement in or on the electric consumer and including a memory for storing at least one identifier of the electric consumer and a telecommunications unit for receiving a query of the monitoring apparatus and transmitting the identifier to the monitoring apparatus, a second way in which said electric consumer is operatively connected with the identifier module by means of circuitry.

21. The electric indoor installation arrangement of claim 20, further comprising a circuit breaker including break contacts for a predeterminable disconnection of at least one conductor of an electric power supply network, and a monitoring apparatus having a device for recording and/or receiving measurement data for recognizing a current flow in at least one part of the electric power supply network, a communications unit for querying and receiving an identifier of the electric consumer, and a comparison unit for comparing a received identifier from the communications unit with a stored reference identifier, said monitoring apparatus being operatively connected, at least indirectly, with the break contacts for triggering an opening of the break contacts.

22. The electric indoor installation arrangement of claim 20, further comprising a circuit breaker including break contacts for a predeterminable disconnection of at least one conductor of an electric power supply network, and a control interface for receiving a switching order of a monitoring apparatus having a device for recording and/or receiving measurement data for recognizing a current flow in at least one part of the electric power supply network, a first communications unit for querying and receiving an identifier of the electric consumer, a comparison unit for comparing a received identifier from the communications unit with a stored reference identifier, and a second communications unit for transmitting a status message and/or a switching order, said control interface being operatively connected, at least indirectly, with the break contacts for triggering an opening of the break contacts.

23. A method for determining the authorization to consume electric power of an electric consumer connected to an electric power supply network, comprising the steps in sequence of:
recognizing a current flow in at least one part of the electric power supply network by a monitoring apparatus;
querying an identifier of the electric consumer through telecommunication;
receiving the identifier of the electric consumer through telecommunication; and
comparing the received identifier of the electric consumer with a reference identifier.
